(19) United States
(12) Patent Application Publication
(10) Pub. No.: US 2004/0247971 A1
(43) Pub. Date: Dec. 9, 2004

(54) One-step consolidation process for manufacturing solid oxide fuel cells

(76) Inventors: Vinod K. Sarin, Boston, MA (US); Uday Pal, Dover, MA (US)

Correspondence Address: Gauthier & Connors LLP, Suite 3300, 225 Franklin Street, Boston, MA, 02110, US

(21) Appl. No.: 10/805,132

(22) Filed: Mar. 19, 2004

Related U.S. Application Data
(63) Continuation of application No. PCT/US02/33094, filed on Oct. 17, 2002.
(60) Provisional application No. 60/330,017, filed on Oct. 17, 2001.

(51) Int. Cl. H01M 8/12; B28B 3/00

(52) U.S. Cl. 429/30; 264/241

(57) ABSTRACT

A process is described for manufacturing a solid oxide fuel cell (SOFC) (400) having a cathode (408), anode (404), and an electrolyte (406) via a one-step powder consolidation process using hot or hot iso-static pressing. The one-step process provides for a means for low-cost, high-volume, high-efficiency manufacturing of planar SOFC-dense electrolyte structures that is sandwiched between a porous anode and cathode electrodes. In addition, multiple cells can be simultaneously pressed using a stacked configuration.

This invention was made with Government Support under Contract Number DE-AC05-96OR22464 awarded by the Department of Energy. The Government has certain rights in this invention.

### BACKGROUND OF THE INVENTION

The invention relates to the field of fuel cells and, in particular, to a low-cost fabrication technique for solid oxide fuel cells (SOFCs).

With the increasing emphasis towards more strict pollution control norms, the focus has shifted onto fuel cells as a source of energy. Higher efficiency, higher specific energy density, and reduced emission of pollutants such as SO₂, NO₂, and CO₂ make these devices a potent replacement for traditional means of generating power. In particular, solid oxide fuel cells seem the most promising technique for power generation.

Solid Oxide Fuel Cell (SOFC):

SOFCs provide a very attractive and versatile means of efficiently converting chemical energy to electrical energy from a wide variety of fossil fuels with much lower environmental impact than conventional power generation systems such as those based on gas turbines. A schematic of an operating SOFC with reformed fossil (hydrocarbon) fuel is shown in FIG. 1.

FIG. 1 illustrates SOFC 100 which converts chemical energy from a variety of fossil fuels to electrical energy. SOFC 100 comprises a porous cathode 102, a porous anode 104, and a solid electrolyte 106. Anode 104 and cathode 106 provide a voltage source 108, wherein anode 104 oxidizes hydrogen in the fuel and cathode 106 reduces oxygen gas in air.

FIG. 2 illustrates a fuel cell stack 200 with multiple cells. A series of stacked repeating cells with plate separators provides the multiple cell structure. The repeating cells comprise, sequentially, an end plate 202, anode 204, electrolyte matrix 206, cathode 208, and bipolar separator plate 210. Current, oxidant and fuel flows are shown for end/separator plates.

Electrical power generation systems based on SOFCs have many advantages: high power generation efficiency since chemical energy is directly converted into electrical energy and there is negligible transmission and distribution losses; cogeneration capability, especially if they are operated at above atmospheric pressures, since the product gases (steam) have a sufficiently high heat content; capability of operating on a wide variety of hydrocarbon fuels and generating much lower NOₓ and SOₓ levels since oxygen and hydrogen are electrochemically reacted; ability to internally reform hydrocarbon fuels because of the elevated operating temperature; high power-to-weight ratio since the fuel cell components are made of light-weight and relatively thin ceramic materials; flexibility in citing due to its lower environmental impact and noise-less operation; lower manufacturing time since the units are modular in nature and can be assembled on site; solid-state structures that can be easily transported; and wide range of applications that include stationary, transportation and military use.

The most successful state-of-the-art high-temperature SOFCs are manufactured by Siemens-Westinghouse. They operate at 900-1100° C., with fuel utilization of 80-90%, and power density in the range of 0.2-0.5 W/cm². The anode, electrolyte, cathode and interconnect materials are Ni—ZrO₂ cermet (electronic conductor), yttria-stabilized zirconia (oxygen-ion conductor), A-site (Sr) doped lanthanum manganite (electronic conductor), and A-site (Mg) doped lanthanum chromite (electronic conductor), respectively. The electrodes (anode and cathode) are 30-40% porous and permit molecular diffusion of gases, and the electrolyte and interconnect are dense. The cathode (1-2 mm thick) is fabricated by green extrusion followed by sintering, the electrolyte (20-40 μm thick) by the electrochemical vapor deposition (EVD) process, the anode (100-150 μm thick) by slurry coating followed by sintering or EVD fixing, and the interconnect (50-100 μm thick) by a plasma-spray process. The cost of producing fuel-cell stacks with these batch-processed cells is estimated to plateau, with all foreseeable improvements, at $1500/kWe. This is still significantly (an order of magnitude) higher than their gas-turbine counterparts.

Research teams at various universities and industries are working on developing processes SOFCs to lower the manufacturing costs. Processing techniques being investigated include: tape calendering, tape casting, plasma-spray, sol-gel, colloidal processing, screen printing, etc. All these are batch processes requiring multiple heating, sometimes to temperatures over 1300° C., and cooling steps that are expensive, time consuming, lowers productivity and are damaging to the individual cell components.

Fabrication techniques, like Electrochemical Vapor Deposition (EVD) for the electrolyte, and the processing technique, being batch type, contributes to the cost. The use of such exotic processes results in a complication of the complete cell manufacturing process along with the need for control over a number of parameters. Apart from the financial burden imposed, it also raises the difficulty of adapting such a system on a commercial scale.

The following references describe SOFCs in general, but they fail to provide for a single-step hot press operation for fabrication of either a single SOFC or a stack of SOFCs.

The European patent to Nishioka et al. (EP0552055A2), assigned to NGK Insulators, Ltd., provides for a process for producing solid oxide fuel cells. Disclosed is a process for producing an SOFC with an air electrode and a fuel electrode provided on opposite surfaces of a solid electrolyte plate.

The German patent to Wersing et al. (DE4307967), assigned to Siemens A G, provides for an Integrated Ceramic High-Temperature Fuel Cell. Described is a method to form a high-temperature solid oxide fuel cell (SOFC) stack.

Whatever the precise merits, features and advantages of the above cited references, none of them achieve or fulfills the purposes of the present invention.

### SUMMARY OF THE INVENTION

The present invention provides for a hot pressing or hot iso-static pressing to fabricate a planar SOFC in a single step. The process involves (a) identifying processing parameters to obtain densification/porosity associated with each individual part (anode, cathode, and electrolyte), (b) selecting a set of parameters to obtain an electrolyte having a density greater than 90% and a cathode/anode having porosity between 20-40%, and (c) hot pressing the entire fuel cell in a single step based on the selected parameters. Multiple SOFCs can be produced by the same single-step hot pressing process by pressing a linear repeating cell structure and associated separators.

The single-step hot pressing technique provides for an electronically conducting porous electrode structure with high gas permeability and a high electronic/ionic/gas contact area provided at the electrode/electrolyte interface and within the electrode, wherein such a structure also provides low gas-phase mass transfer resistance and low electrode-polarization resistance. Further porosity control in the electrode is obtained by using carbon powder/fiber or other pore formers.

By removing multiple batch processing and by simplifying the manufacturing process, considerable cost reduction is accomplished. Additionally, by optimizing the process, reduction in both the processing time and cost are obtained.

### BRIEF DESCRIPTION OF THE DRAWINGS

FIG. 1 illustrates a prior art schematic of a SOFC that converts chemical energy from a variety of fossil fuels to electrical energy.

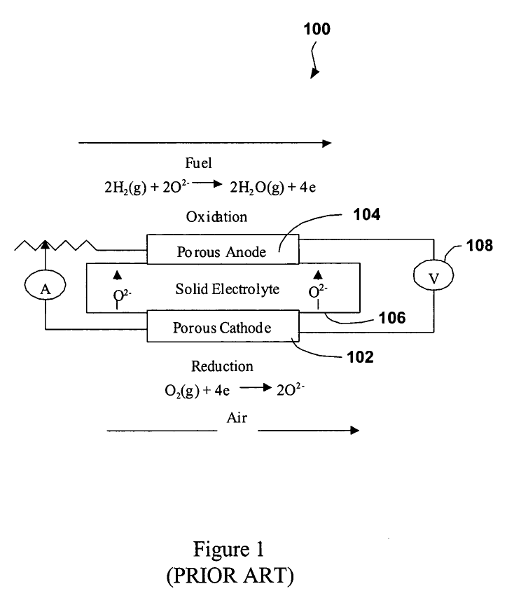

FIG. 2 illustrates a schematic of a multi-cell SOFC that converts chemical energy from a variety of fossil fuels to electrical energy.

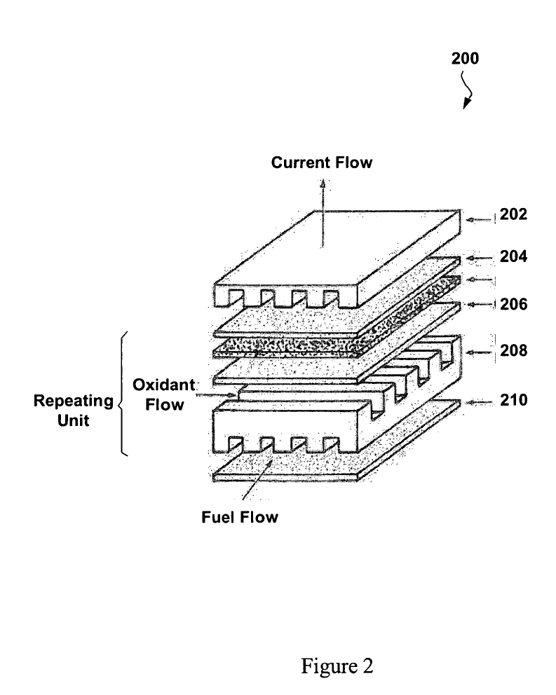

FIG. 3 illustrates an example of a hot press that can be used in conjunction with the present invention.

FIG. 4 illustrates a schematic of hot pressing an entire planar fuel cell as per the present invention.

FIG. 5 illustrates a schematic representation of high-temperature SOFC hot pressed with a wavy die and fractured cross section (inset) showing C:cathode, E:electrode, and A:anode.

FIG. 6 illustrates polished dense (>95%) YSZ electrolyte-porous cathode interface of a sample hot pressed at 1,100° C.

FIG. 7 illustrates an optimized structure of a hot pressed intermediate-temperature SOFC.

FIG. 8 illustrates a cross-sectional SEM micrograph showing the nature of the porosity in the densified sample containing carbon powder.

FIG. 9 illustrates the same sample after being oxidized at 1,000° C. to try and burn out the carbon.

FIG. 10 illustrates a cross-sectional SEM micrograph showing the densified sample containing carbon fibers.

FIG. 11 illustrates the same sample shown in FIG. 10 after oxidation to burn out the carbon.

### DETAILED DESCRIPTION OF THE INVENTION

Although the present invention has been shown and described with respect to several preferred embodiments thereof, various changes, omissions and additions to the form and detail thereof, may be made therein, without departing from the spirit and scope of the invention.

It should be noted that although the specification discloses a one-step process for fabricating a solid oxide fuel cell, the present invention's process is envisioned to be encompass the manufacture of a plurality of fuel cells in a one-step process. Thus, the number of SOFCs fabricated using the disclosed process should not be used to limit the scope of the present invention. Additionally, although examples in the specification describe consolidating the fuel cell structure via hot pressing, it should be noted that other alternatives and equivalents are also envisioned. For example, the hot pressing step of the present invention's process can be replaced by a hot iso-static press without departing from the scope of the present invention.

The present invention provides for a hot pressing or hot iso-static pressing to fabricate a planar SOFC in a single step. The process involves (a) identifying processing parameters to obtain densification/porosity associated with each individual part (anode, cathode, and electrolyte), (b) selecting a set of parameters to obtain an electrolyte having a density greater than 90% and a cathode/anode having porosity between 20-40%, and (c) hot pressing the entire fuel cell in a single step based on the selected parameters.

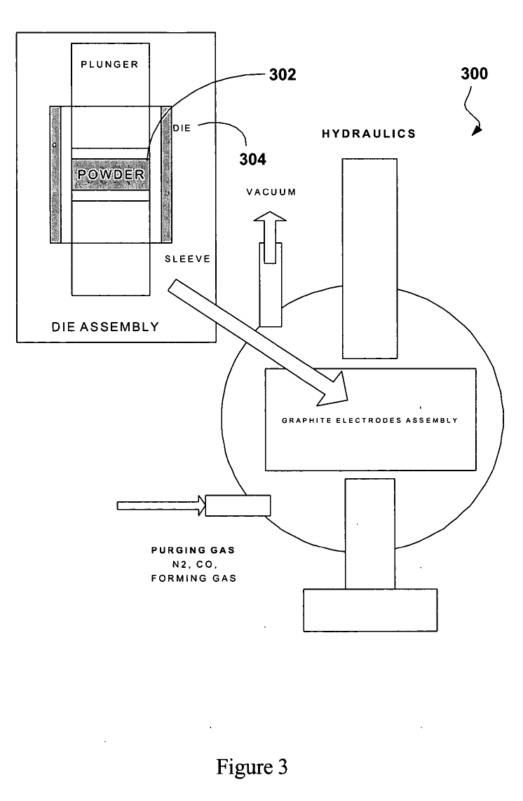

FIG. 3 illustrates an example of a hot press 300 that can be used in conjunction with the present invention, wherein the hot press has a graphite-heating element. It should be noted that other equivalent presses are within the scope of the present invention. The powders are pre-processed by wet milling in methanol for approximately four hours for de-agglomeration and then dried at 600° C. for eight hours to remove the adsorbed species. The powder 302 is put into a die 304 which can be first coated with boron nitride slurry to prevent adhesion between the powder and the sleeve. The powder 302 is pre-pressed and then hot pressed under vacuum at a specified temperature and pressure. The displacement, applied pressure, and vacuum are recorded as a function of the temperature.

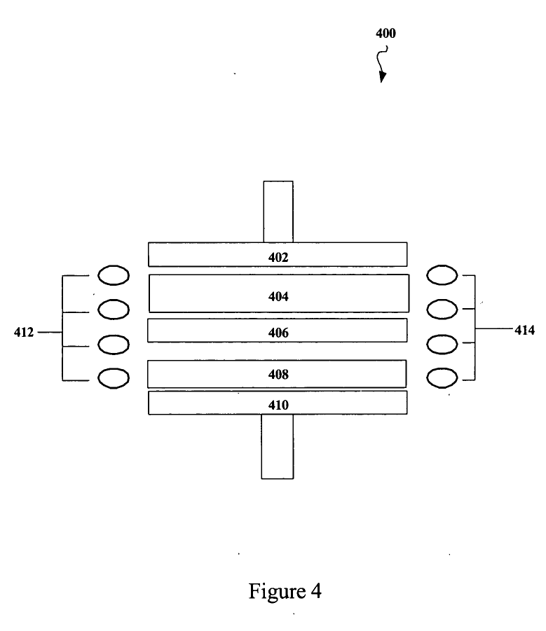

FIG. 4 illustrates a schematic of the powdered layers which are pressed together (under heat) to produce SOFC 400. The SOFC is manufactured using a pair of plungers 402, 410 and a plurality of heating elements 412, 414. The SOFC is formed by consolidating, via a single step, an anode layer 404, an electrolyte layer 406, and a cathode layer 408.

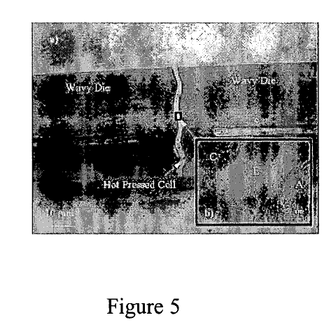

An illustrative embodiment comprising an entire high-temperature SOFC structure of dense yttria-stabilized zirconia (YSZ) electrolyte, porous strontium doped lanthanum manganite cathode and a porous nickel-zirconia cermet anode has been hot pressed in a single step with a wavy die as shown in FIG. 5. It demonstrates that, the interfacial area between the electrode and the electrolyte can be increased through die design in order to reduce the effective charge-transfer resistance. By using a wavy die it is possible to shape the gas channels directly in the electrodes. However, straight and other shaped dies are within the scope of the present invention. In addition, it is evident to one skilled in the art that the interfaces between the components can be compositionally graded to decrease residual stresses arising during thermal cycling.

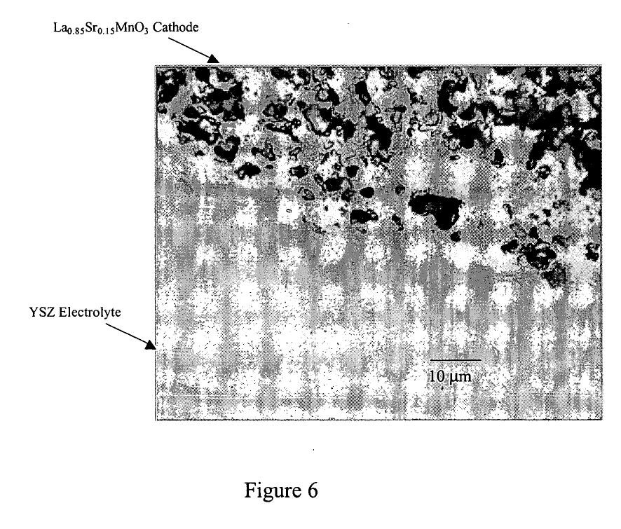

FIG. 6 shows the polished interface between a porous electrode (cathode) and the YSZ electrolyte that was hot pressed at 1100° C. with 2,500 psi pressure for 30 minutes. The variation in density between the YSZ electrolyte (fully dense) and the electrodes (porous) is attained by controlling the particle size and distribution of the original powders. For example commercially available YSZ powders with a wide range of particle sizes, with mean diameters ranging from nano (<0.1 μm) to 1500 μm were investigated. It was established that YSZ could be densified to greater than 90% without interconnected porosity at temperature as low as 1000° C. and pressures in the 2500 psi range when the mean particle diameter of the starting powder was 5 μm and below. For those skilled in the art of PM (powder metallurgy) it should be evident that further modifications in powder morphology and distribution, via milling, may yield even lower YSZ densification process parameters.

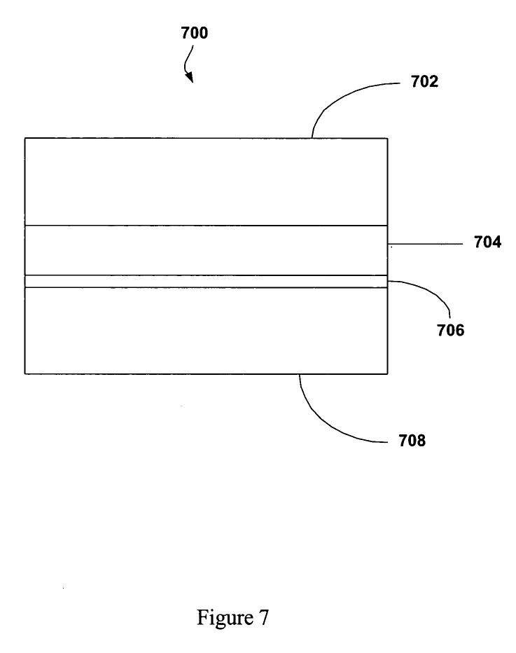

The present invention hot pressing process can also be used for one-step manufacturing of solid oxide fuel cell that operates at intermediate temperatures (600-800 degrees C.). FIG. 7 illustrates an example of an intermediate temperature solid oxide fuel cell 700 comprising a dense electrolyte 704, porous anode 708, and a porous cathode 702 based on lanthanum gallate (La₁₋ₓ,SrₓGa_{1-y}Mg_{y}O_{3-δ} or LSGM), nickel-ceria (Ce_{0.9}Y_{0.1}O₂₋ₓ) cermet, and LSGM-lanthanum cobaltite (La_{0.8}Sr_{0.2}CoO₃, or LSC) composite, respectively. The cathode 702 and the anode 708 are about 20-40% porous (5-15 μm pores), and about 100 μm to 2 mm thick. On the other hand, the electrolyte 704 is about 5-20 μm thick. The intermediate temperature SOFC 700 further comprises a layer 706 of particulate phases at the anode-electrolyte interface (Y₂O₃ Doped-CeO₂). These material choices meet the operational requirements of the intermediate-temperature SOFC. The development of the one-step hot pressing process would involve determining the range of hot-pressing parameters for the individual components and then identifying a common range of parameters to hot press the entire intermediate-temperature SOFC structure in one step. This can be done in an iterative manner by electrochemically, chemically, and mechanically evaluating the hot-pressed components and relating the process parameters to the respective structures and properties obtained. The processing parameters that need to be tailored would include: particle size and distribution in the starting powders, hot pressing environment, temperature, pressure and die design, interfacial composition, and relative amounts of the phases in the cermet anode and the composite cathode. The process can then be also used to press multiple cells at a time in order to assemble a fuel cell stack with metallic interconnects.

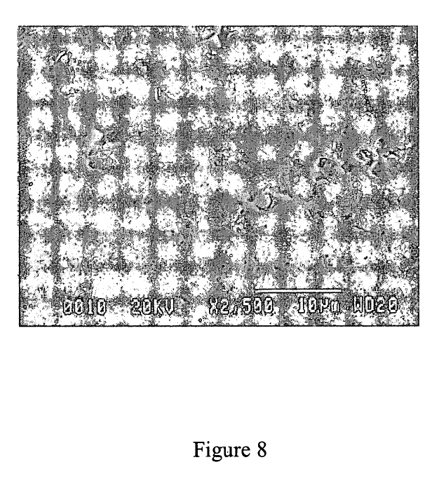

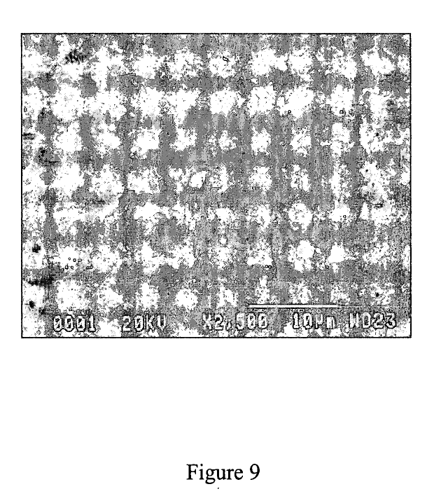

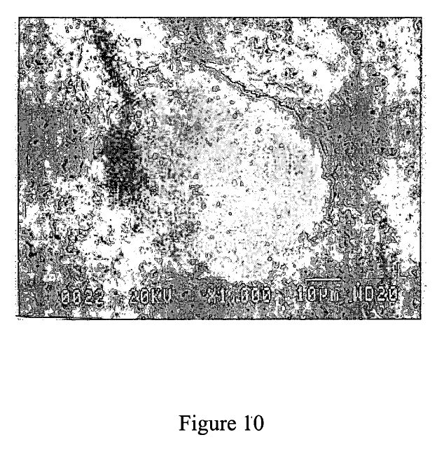

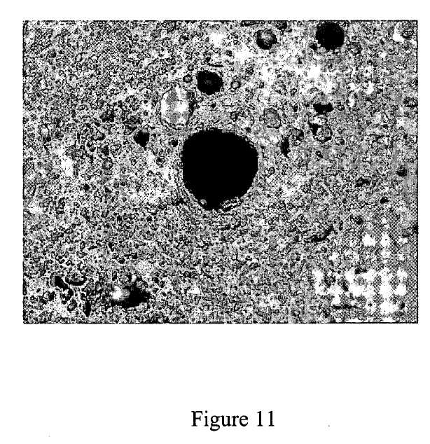

Additionally, porosity control can be further achieved by mixing the Sr doped LaMnO₃ powder with C powder (30% by volume), carbon fibers, corn starch, and/or functional equivalents. FIG. 8 illustrates a cross-sectional SEM micrograph showing the nature of the porosity in the densified sample containing carbon powder. FIG. 9 illustrates the same sample after being oxidized at 1,000° C. to try and burn out the carbon. It should be noted that no carbon peaks were detected via XRD analysis. FIG. 10 illustrates a cross-sectional SEM micrograph showing the densified sample containing carbon fibers. The sample showed no reaction between the parent matrix and the carbon fibers. FIG. 11 illustrates the same sample after oxidation to try and burn out the carbon. However, it is to be noted that it is possible to obtain the desired porosity in the electrode structure by tailoring the powder size and distribution along with proper selection of the hot pressing load and temperature.

The process of the present invention offers many advantages, some of which are listed below:

(1) the disclosed process significantly lower the process cost;

(2) the disclosed process improves interfacial contact and lowers interfacial resistance;

(3) the disclosed process allows graded structures to be developed for lowering internal stresses during thermal cycling; and

(4) the disclosed process increases the gas-ionic-electronic contact area in the electrodes and lower electrode polarization losses.

What is claimed is:

1. A consolidation process for single step manufacturing of a solid oxide fuel cell (SOFC), said cell comprising a cathode, electrolyte, and anode, said consolidation process comprising the steps of:
(a) assembling a layered structure of powdered materials representing sequentially said cathode, electrolyte, and anode;
(b) selecting process parameters to yield a dense electrolyte and cathode and anode, with controlled porosity; and
(c) consolidating the entire layered structure in a single step based on said selected process parameters.

2. A consolidation process for single step manufacturing of a solid oxide fuel cell (SOFC), as per claim 1, wherein said process parameter of said electrolyte is selected to yield an electrolyte density greater than 90% and a cathode/anode porosity level between 20-40%.

3. A consolidation process for single step manufacturing of a solid oxide fuel cell (SOFC), as per claim 1, wherein multiple SOFCs can be produced by consolidating a linear repeating cell structure and associated separators.

4. A consolidation process for single step manufacturing of a solid oxide fuel cell (SOFC), as per claim 3, wherein said associated separators comprise thin boron nitride or alumina discs.

5. A consolidation process for single step manufacturing of a solid oxide fuel cell (SOFC), as per claim 1, wherein said step of consolidating said layered structure in a single step is done either via hot iso-static pressing or hot pressing.

6. A consolidation process for single step manufacturing of a solid oxide fuel cell (SOFC), as per claim 1, wherein said process further comprises the step of controlling electrode/electrolyte interfacial area via a wavy die configuration.

7. A consolidation process for single step manufacturing of a solid oxide fuel cell (SOFC), as per claim 1, wherein said powdered materials are selected to yield SOFCs that can be operated either at high temperature of about 1000° C. or at a medium temperature between 600 to 700° C.

8. A consolidation process for single step manufacturing of a solid oxide fuel cell (SOFC), as per claim 1, wherein said consolidation step is performed at a temperature chosen within the range of 900-1200° C.

9. A consolidation process for single step manufacturing of a solid oxide fuel cell (SOFC), as per claim 1, wherein said consolidation step is performed at a pressure chosen within the range of 2000-5000 psi.

10. A consolidation process for single step manufacturing of a solid oxide fuel cell (SOFC), as per claim 1, wherein said anode/cathode further comprises any of the following pore formers: carbon powder, carbon fibers, or corn starch.

11. A consolidation process for single step manufacturing of a solid oxide fuel cell (SOFC), as per claim 10, wherein said process additionally comprises the step of heating said consolidated layered structure to burn out added pore formers.

12. A solid oxide fuel cell (SOFC) manufacturing system, said cell including at least a cathode, electrolyte, and anode, said system comprising:
(a) a hot press, said press including heating and pressurization capabilities;
(b) a layered structure of powdered materials representing sequentially a cathode, electrolyte, and anode, said layered structure received in said hot press;
(c) a die configuration; and
said solid oxide fuel cell created by hot pressing the entire layered structure in a single step using said die configuration and selected heating and pressurization parameters.

13. A solid oxide fuel cell (SOFC) manufacturing system, as per claim 12, wherein said manufacturing system yields an electrolyte density greater than 90% and a cathode/anode porosity level between 20-40%.

14. A solid oxide fuel cell (SOFC) manufacturing system, as per claim 12, wherein multiple solid oxide fuel cells can be produced by hot pressing a linear repeating layered structure and additional separators.

15. A solid oxide fuel cell (SOFC) manufacturing system, as per claim 14, wherein said separators comprise thin boron nitride or alumina discs.

16. A solid oxide fuel cell (SOFC) manufacturing system, as per claim 12, wherein said hot press is replaced by a hot iso-static process.

17. A solid oxide fuel cell (SOFC) manufacturing system, as per claim 12, wherein said die configuration comprises a wavy die to control surface area.

18. A solid oxide fuel cell (SOFC) manufacturing system, as per claim 12, wherein said powdered materials are selected to yield SOFCs that can be operated either at high temperature of about 1000° C. or at a medium temperature between 600 to 700° C.

19. A solid oxide fuel cell (SOFC) manufacturing system, as per claim 12, wherein said hot pressing is performed at 900-1200° C.

20. A solid oxide fuel cell (SOFC) manufacturing system, as per claim 12, wherein said hot pressing is performed at 2000-5000 psi.

21. A solid oxide fuel cell (SOFC) manufacturing system, as per claim 12, wherein said anode or cathode further comprises any of the following pore formers: carbon powder, carbon fibers, or corn starch.

22. A solid oxide fuel cell (SOFC) manufacturing system, as per claim 21, wherein said system further comprises heating said hot pressed layered structure to burn out added pore formers.

23. A consolidation process for single step manufacturing of a solid oxide fuel cell (SOFC), said cell comprising a cathode, electrolyte, and anode, said consolidation process comprising the steps of:
(a) assembling a layered structure of powdered materials representing sequentially said cathode, electrolyte, and anode, and
(b) hot pressing said layered structure in a single step to create a SOFC comprising a highly dense electrolyte, a cathode, and a anode, whereby the density associated with said electrolyte is greater than 90% and the porosity of said cathode and anode is between 20-40%.

24. A consolidation process for single step manufacturing of a solid oxide fuel cell (SOFC), as per claim 23, wherein multiple SOFCs can be produced by hot pressing a linear repeating layered structure and additional separators.

25. A consolidation process for single step manufacturing of a solid oxide fuel cell (SOFC), as per claim 23, wherein said powdered materials result in solid oxide fuel cells that can operate at either high or medium temperatures.

26. A consolidation process for single step manufacturing of a solid oxide fuel cell (SOFC), as per claim 23, wherein said hot pressing is replaced by a hot iso-static pressing.

27. A consolidation process for single step manufacturing of a solid oxide fuel cell (SOFC), as per claim 23, wherein said electrolyte comprises a substantially non-interconnected porosity and said anode and cathode have at least partially interconnected porosity.

28. A consolidation process for single step manufacturing of a solid oxide fuel cell (SOFC), as per claim 23, wherein interconnects are additionally pressed into said layer structure during hot pressing.
